(19) United States
(12) Patent Application Publication
(10) Pub. No.: US 2018/0199125 A1
(43) Pub. Date: Jul. 12, 2018

(54) ACOUSTIC TRANSMIT-RECEIVE TRANSDUCER

(71) Applicant: WIZEDSP LTD., TEL-AVIV (IL)

(72) Inventor: OZ GABAI, TEL-AVIV (IL)

(21) Appl. No.: 15/741,792

(22) PCT Filed: Jul. 6, 2016
(86) PCT No.: PCT/IB2016/054034

§ 371 Date: Jan. 4, 2018

Related U.S. Application Data
(60) Provisional application No. 62/189,009, filed on Jul. 6, 2015.

(51) Int. Cl. H04R 1/04; H04R 19/04; H04R 1/08

(52) U.S. Cl. CPC H04R 1/04; H04R 19/02; H04R 1/08; H04R 19/04

(57) ABSTRACT

An acoustic transducer including a transducer including a first rigid conductive grid, a second rigid conductive grid, and an elastic conductive diaphragm located between the first rigid conductive grid and the second rigid conductive grid, a power supply having an input voltage VCC and providing a first LOW VCC supply voltage, and a second inverted voltage, a driving circuit operating the transducer as an electrostatic speaker, a buffer circuit operating the transducer as an electrostatic microphone, a switch selecting between electrostatic speaker and a microphone, a main supply input, a signal input, and an output.

### CROSS-REFERENCE TO RELATED APPLICATIONS

This application claims the benefit of U.S. Provisional Application No. 62/189,009, filed Jul. 6, 2015, the disclosures of which is incorporated herein by reference in their entirety.

### FIELD

The method and apparatus disclosed herein are related to the field of electronic circuitry, and, more particularly, but not exclusively to a system and method for providing a transducer for transmitting and receiving acoustic signals.

### BACKGROUND

In recent years we are seeing a fast growth in technology, especially in communication, which is a trigger to other technologies. These technologies affect big data clouds that collect all around information. These data clouds store things about each one of us, driving traffic and much more. Using these cloud centers may be used to make our lives better.

At around 1992 the world wide web network has emerged, in which local computers at home or office have been connected to a huge network, the World Wide Web (WWW), which is also known as the Internet. It was the time when suitable protocols have developed and communication devices and technology for this task emerged. At that time people used the V34 MODEM to connect a local computer to the WWW network, the internet.

Even at that time, the internet has changed our lives by: Having extreme amount of information available to us—books, traffic medicine, academic information and much more. Making the global world accessed by each one of us—trading.

Today, each one of us has a smart phone with the capability to connect to the internet. Therefore, each one of us have a huge amount of information accessible in the palm of our hands, However, on the other side, corporations have started to collect information for the benefits of targeted marketing, like for example using Global Positioning Systems data. Many applications for Smartphones emerged, like navigation applications that report speed of traveling and would allow the server on the internet to optimize and calculate the most efficient rout, like for example the WAZE application.

The technology is advancing every day rapidly, and some have forecasted that by 2020 more than 50,000,000,000 devices may be connected to the internet, some of these devices are: Light bulbs, Light switches, Air conditions, Tools such as screwdrivers, Tooth brushes, Medical devices such as potable blood pressure, Books, Toys.

The motivation to connect all of these devices to the internet is to make our lives better by having the ability to control and observe information instantly, and also to track information for future usage. An example to that may be putting a sensor on a tooth brush that will collect information about the state of the teeth and would transfer the information back to the dentist.

In a smart home, the ability to control the lights can make the light bulbs smart devices having many applications. The ability to connect electricity devices to the internet would allow us to save money. A dryer machine for example, which is connected to the internet, can get the rate of energy cost at different times of the day and hence to run the dryer on times where the cost of the energy is minimal.

Connected toys will have many application like talking dolls and educational games.

Connecting the all-around devices we have at home, such as electrical devices, bath devices, books tools etc. will allow making these devices observable and controllable, in which it can benefit our lives and make them better and more efficient.

In order to allow connection of merely all items to the internet, one needs to have a physical layer to carry the information from and to the devices. Some of the devices would have a power source such as air conditioner or a light bulb, but most objects and items like bath room objects, bad room objects, tools etc. would not have any power source, and therefore would need to run on a battery or on energy harvesting.

One method to run those transceivers is to use an RF harvested energy solution. This in fact requires emission of high power 30-100 times compared with cell phone running on GSM, and therefore it is applicable only in industrials application. At home, office and all around us, the items which do not have a power source would need to run on batteries. Moreover, as the communication is basically “on demand” and not usually “contented”, the transceiver modules attached to these objects will normally be in a standby mode, waiting for some “wakeup” beacon or s signaling information.

There is thus a widely recognized need for, and it would be highly advantageous to have, a system and method providing a transducer for transmitting and receiving acoustic signals, devoid of the above limitations.

### SUMMARY

According to one exemplary embodiment there is provided a device and a method for an acoustic transducer including a transducer including a first rigid conductive grid, a second rigid conductive grid, and an elastic conductive diaphragm located between the first rigid conductive grid and the second rigid conductive grid, a power supply having an input voltage VCC and providing a first LOW VCC supply voltage, and a second inverted voltage, a driving circuit operating the transducer as an electrostatic speaker, a buffer circuit operating the transducer as an electrostatic microphone, a switch selecting between electrostatic speaker and a microphone, a main supply input, a signal input, and an output.

According to another exemplary embodiment of the acoustic transducer the microphone is a Micro Electro-Mechanical System (MEMS) microphone.

According to still another exemplary embodiment, at least one of the transducer, the driving circuit, and the buffer circuit, operates from 14000 Hz and above.

According to yet another exemplary embodiment, the power supply is a switching power supply.

Further according to another exemplary embodiment, the power supply is connected at its input to the main supply input, and has a first low supply voltage output, a second high supply voltage for the conductive diaphragm, and third, at least one inverted supply voltage.

Still further according to another exemplary embodiment, the power supply low voltage is implemented using a switching capacitor step down and each inverted output is implemented using a diode clamp switch capacitor circuit, and the second high voltage is implemented using a switch capacitor voltage multiplier circuit.

Yet further according to another exemplary embodiment, the power supply low voltage has a low pass filter at the output.

Even further according to another exemplary embodiment each of the inverted outputs and the high voltage has a low pass filter.

Additionally, according to another exemplary embodiment, the switch is a dual pole double through switch, with a first and second normal close pins, and a third and a fourth normal open pins.

According to yet another exemplary embodiment, the third and the fourth normally-open pins of the switch are connected to a first node of a first resistor and a first node of a second resistor, having their second pins attached to ground.

According to still another exemplary embodiment, the electrostatic drive circuit includes a dual buffer, where the first buffer is connected to the switch first normally-closed pin, and the second buffer output is connected to the switch second normally-closed pin.

Further according to another exemplary embodiment, the buffer circuit includes a single buffer and connected with its input to the signal input.

Still further according to another exemplary embodiment, the buffer includes a MOSFET or a JFET transistor, a bias resistor connected with its first node to the gate of the transistor, a source terminal of the transistor connected to a first pin of a source resistor, having the second pin of the source resistor connected to ground, a drain terminal of the transistor connected to a first pin of a drain resistor, and a second pin of the drain resistor connected to the switching power supply low voltage, a coupling capacitor connected with its first pin to the first or third rigid conductive grids, and its second pin connected to the transistor gate pin, a source capacitance connected in parallel to the source resistor, a comparator or an OP amplifier including a first pin “+:” pin connected to a reference voltage first node, where the second node of the reference voltage is connected to the ground, a second pin “−” connected to the source pin through a bi-directional noise blocking filter, a third pin, connected to the main supply, a fourth pin connected to the inverted supply, and a fifth pin which is the output connected to an input of a noise blocking filter, having its output connected to a first pin of a feed resistor connected with its second pin to the second pin of the bias resistor, and a first pin of a capacitor having its second pin connected to the ground, and an output node connected to the drain of the transistor.

Yet further according to another exemplary embodiment, the buffer includes a first buffer with positive gain +A, and a second buffer with a negative gain −A, where the inputs of the first and second buffers are connected to the input signal.

Even further according to another exemplary embodiment, each buffer includes a MOSFET or a JFET transistor, where the first buffer includes a bias resistor connected with its first node to the gate of the first buffer transistor, the first buffer transistor source, connected to a first pin of a source resistor, having the second pin of the source resistor connected to ground, the first buffer drain pin connected to the first pin of a first drain resistor, and the second pin of the first drain resistor connected to the switching power supply low voltage, a coupling capacitor connected with its first pin to the first conductive grid and its second pin connected to the first buffer transistor gate pin, a source capacitance connected in parallel to the source resistor, and a first comparator or OP amplifier, including 5 pins, where a first pin “+:” pin connected to a reference voltage first node, where the second node of the reference voltage is connected to the ground, a second pin “−” connected to the first buffer transistor source pin through a first bi-directional noise blocking filter, a third pin, connected to the main supply, a fourth pin connected to the inverted supply, and a fifth (output) pin connected to an input of a first noise blocking filter, having its output connected to a first pin of a first feedback resistor connected with its second pin to a second pin of a bias resistor and a first pin of a capacitor having it second pin connected to the ground, and a first output node connected to the drain of the first buffer transistor, and where the second buffer includes a bias resistor connected with its first node to the gate of the second buffer transistor, a second buffer transistor source connected to a first pin of a source resistor, having the second pin of the source resistor connected to ground, a second buffer drain pin connected to the first pin of a second drain resistor and the second pin of the second drain resistor connected to the switching power supply low voltage, a coupling capacitor connected with its first pin to the third conductive grid and it second pin connected to the second buffer transistor gate pin, a source capacitance connected in parallel to the source resistor; a second comparator or OP amplifier, having 5 pins a first pin “+:” pin connected to a reference voltage first node, where the second node of the reference voltage is connected to the ground, a second pin “−” connected to the second buffer transistor source pin through a second bi-directional noise blocking filter, a third pin, connected to the main supply, a fourth pin connected to the inverted supply, and a fifth pin which is the output, is connected to an input of a second noise blocking filter, having its output connected to a first pin of a second feedback resistor, which is connected with its second pin to the second pin of the bias resistor, and a first pin of a capacitor having its second pin connected to the ground, and a second output node connected to the transistor drain of the second buffer transistor.

Additionally, according to another exemplary embodiment, the output is taken as a differential output between the first output and the second output.

According to yet another exemplary embodiment, the low voltage switching capacitor circuit works with low frequency and the inverted voltage supply is working with high frequency.

According to still another exemplary embodiment, the inverted voltage supply oscillator has two states, the first is enable where the oscillator works, the second is disable where the high frequency oscillator is disabled.

Further according to another exemplary embodiment, the acoustic transducer includes a control pin including a first state connecting the first and third rigid conductive grids to the first and second buffers output pins, and a second state connecting a first pin of a first resistor to the first rigid conductive grid, and the first pin of a second resistor to the third rigid conductive grid.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified block diagram of a personal computer connected to the WWW;

FIG. 2 is a simplified block diagram of a wakeup transceiver;

FIG. 3A is a simplified illustration of an acoustic transmit and receive transducer;

FIG. 3B is a simplified electric schematic an acoustic transmit and receive transduce;

FIG. 4 is a simplified illustration of the acoustic transducer as a transmitter-speaker;

FIG. 5A is a simplified illustration of the acoustic transducer as a microphone, according to one exemplary embodiment;

FIG. 5B is a simplified electric schematic of the acoustic transducer as a microphone, according to one exemplary embodiment;

FIG. 5C is a simplified illustration of an acoustic element circuit model;

FIG. 6 is a simplified illustration of Cmic0 and Cmic1 as integral over X direction;

FIG. 7 is a simplified illustration of a DC-to-DC step down supply voltage;

FIG. 8 is a simplified illustration of simulation results for the circuit of FIG. 7;

FIG. 9 is a simplified electric schematic of the negative voltage generation using a simple charge pump circuit; and

FIG. 10 is a simplified electric schematic of a negative voltage supply VEE and VEE1.

### DETAILED DESCRIPTION

The invention in embodiments thereof comprises systems and methods for acoustic transceiver transducer. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of embodiments described below is to provide at least one system and/or method for an acoustic transceiver transducer. More particularly, but not exclusively, the acoustic transducer may alternate, quickly and efficiently, between input mode as a microphone, and output mode as a loudspeaker, consuming minimum power, and/or producing minimum noise. More particularly, but not exclusively, the transducer may be used with battery-operated devices that have relatively long time operating in standby mode, and/or where immediate wakeup procedure is required. However, the systems and/or methods as described herein may have other embodiments in similar technologies of local area communication.

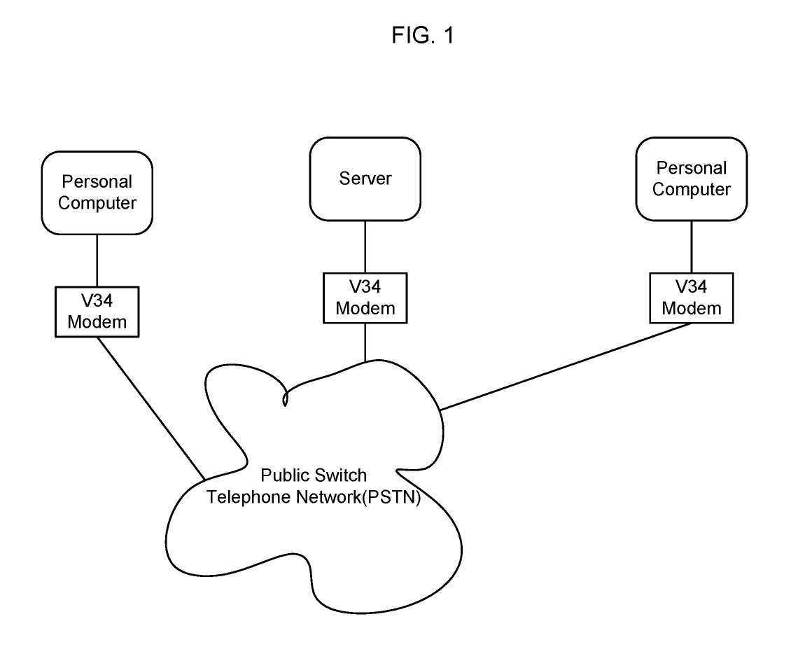

FIG. 1 is a simplified block diagram of a personal computer connected to the WWW, according to one exemplary embodiment.

Particularly, FIG. 1 shows the use of a modulator-demodulator (modem) in communication, providing connectivity between computing devices, and particularly communication via the word-wide web.

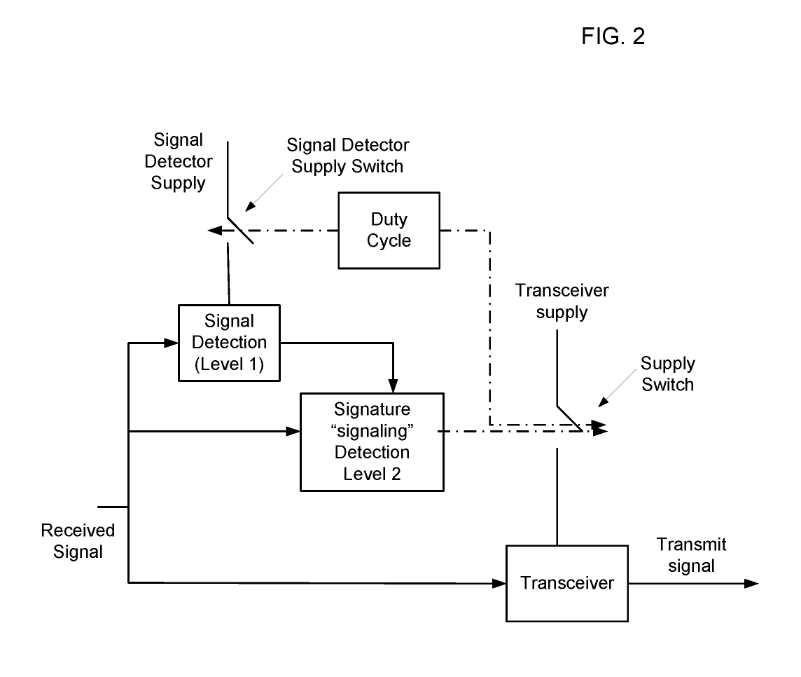

FIG. 2 is a simplified block diagram of a wakeup transceiver, according to one exemplary embodiment.

FIG. 2, represents the general building blocks of a transceiver that most of the time is in a standby mode. Such receiver needs to be responsive to a “control” or a “request” command, and can periodically transmit information. For example, a temperature sensor will most of the time stay in standby mode, and periodically transmit its reading. The transceiver of FIG. 2 may use any communication technology including acoustic communication technology or RF communication technology. The transceiver may include a receiver and a transmitter. It is appreciated that a modem, such as the mode, of FIG. 1, may be regarded as a transceiver, and vice versa.

There are two basic implementations, which are both represented by FIG. 2. The first implementation is a duty cycle receiver, in which the receiver is operating during a small window in time. An example to that may be a window of 1 msec every 1 sec, in which during it, the signal detector checks for a presence of a signal in the desired band width. If a signal is present, then a second level is activated to test some kind of signature or a preamble. If level 2 test is passed, then the receiver is opened by switching on the transceiver power supply. This is similar to the way Bluetooth Low Energy works. This kind of receiver may have a miss-detect probability that may lead sometimes for a longer response time, and is therefore not suitable for remote control applications.

A second implementation of a wakeup receiver would have the signal detector operating at all times. This implementation would result with a miss-detect probability close to 0, but higher false alarm ratio. The level 1 detector in the RF may be implemented using a low power envelope detector. A second level of detection may be activated only when a signal is presented. This kind of receiver may be more suitable for fast response receiver and may be suitable for most remote control applications.

It may be assumed that Bluetooth Low Energy (BLE) and ZigBee will be used in battery operated devices. However, the power consumption of such Radio Frequency (RF) Transceivers is basically too high to operate for several years on batteries. Moreover, BLE which is considered a low power transceiver, would work for about 10 to 12 months using a CR2032 coin cell battery. The size of the CR2032 battery having a diameter of 20 mm and a height of 3.2 mm, is relatively too big for many wearable and IoT applications, such as a smart tooth brush which is connected to the internet.

The problem with RF may be divided into two problems: the first is usually associated with the high carrier, which requires power-hungry mixers and oscillators. The second is the relatively high bandwidth

Acoustic communication usually works with low carrier of a few kHz and would usually work with a low bandwidth. Therefore, acoustic communication is using less power than an RF communication, and so has an advantage in battery operated devices.

Acoustic transceivers may be suitable for battery operated Internet of Things (IoT) devices, that may need to work using a very small battery, and last for a few years. Such a transceiver, usually would need an ultra low power microphone and an efficient speaker for receiving and transmitting the signal respectively. Moreover, these acoustic transceivers would need to be very cheap in order to establish themselves as a true competitor to Bluetooth.

One purpose of the present embodiments is to provide an acoustic transducer that can be used for both transmitting signals as a speaker and receiving signals as a microphone, while working in the range of 14000 Hz and above.

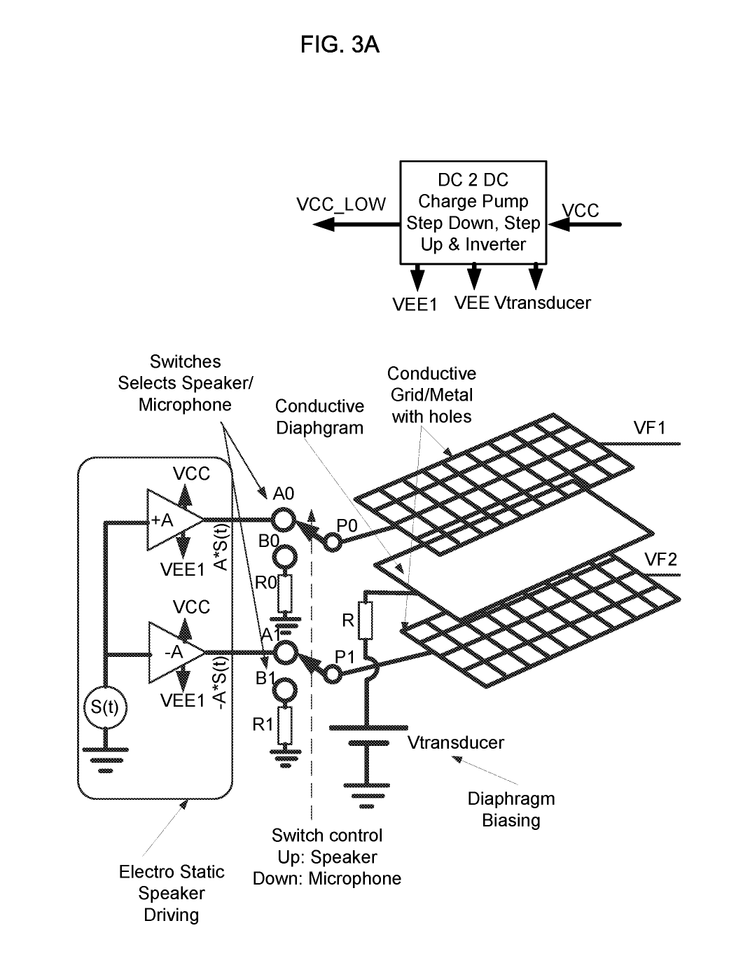

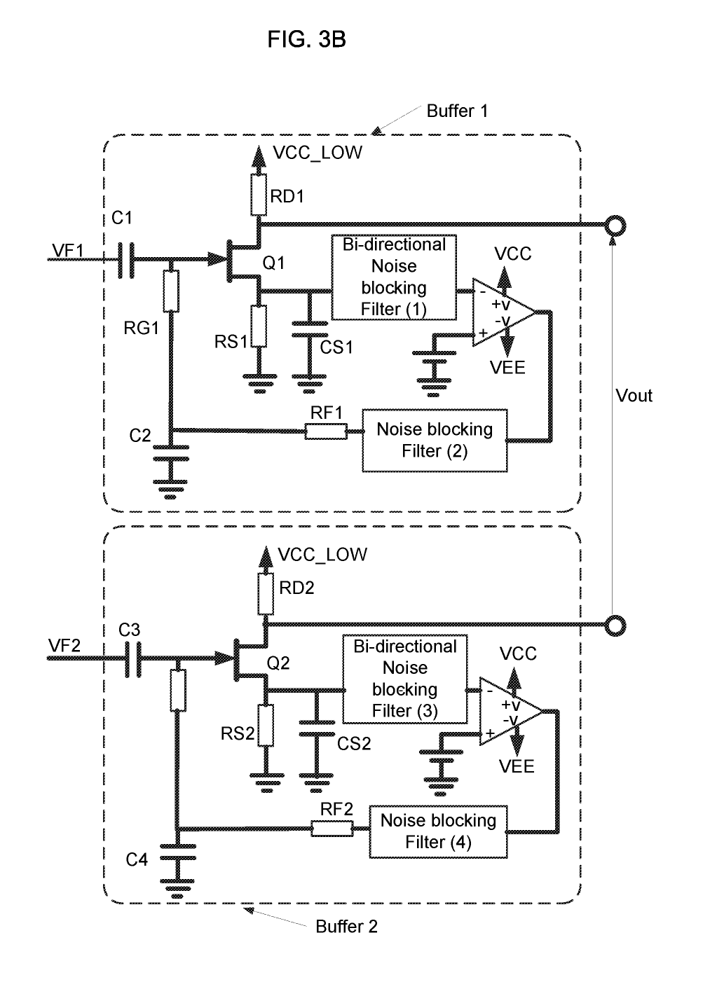

FIG. 3A is a simplified illustration of an acoustic transmit and receive transducer, according to one exemplary embodiment.

FIG. 3B is a simplified electric schematic an acoustic transmit and receive transducer, according to one exemplary embodiment.

The transducer of FIG. 3A and FIG. 3B may include an acoustic element built of two fixed conductive grids or metal with holes (these grids are rigid and fixed), and a conductive elastic diaphragm. This acoustic element is used both for transmitting, as an electrostatic speaker and for receiving as a microphone.

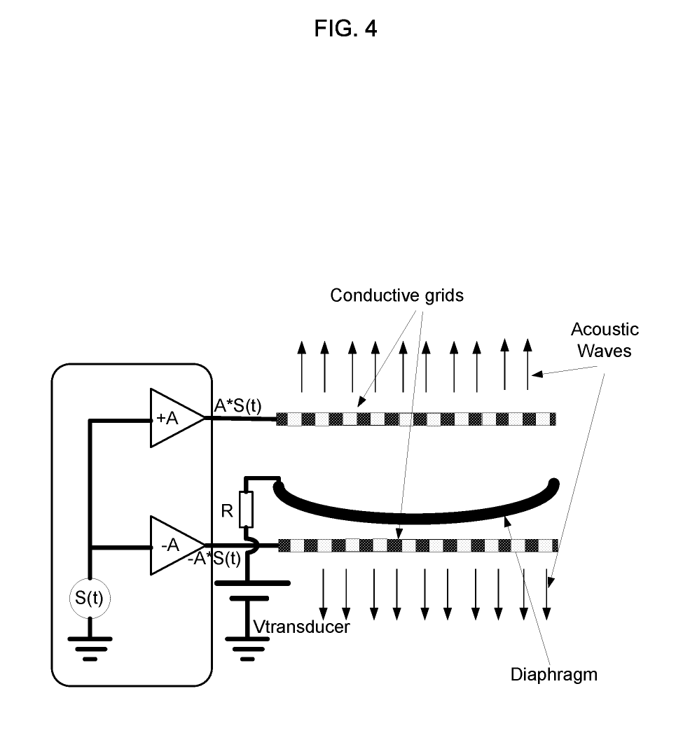

As shown in FIG. 3A, when operating as a speaker, the two switches P0 and P1 are in the up position (e.g., connecting to A0 and A1, respectively). A0 and A1 are connecting the driving amplifiers providing a positive signal A*S(t) to P0 via A0, and the negative −A*S(t) to P1 via A1. In this case, the acoustic element capacitor may be charged with charge Q via resistor R. This in turn may create an electric force field that may cause attraction of the conductive elastic diaphragm to the upper grid, and detraction from the lower grid, or vice versa, depending on the signals in points P0 and P1. These forces are described by FIG. 4.

FIG. 4 is a simplified electric schematic of the acoustic transducer as a transmitter-speaker, according to one exemplary embodiment.

When working as a transmitter, the acoustic pressure waves may be generated through the conductive rigid grids. The electrostatic speaker draw the negative voltage from VEE1. This negative voltage generation is needed to generate more current for the speaker.

Note on size and power: a smartphone speaker may usually consume 1 Watt and will generate 95 dB SPL at 1 kHz at 1 meter. This means that the maximal voltage for Digital To Analog on a smart phone is about \sqrt{8}volts for a speaker of 4 ohm

$$( as 1 watts = \frac{{( \sqrt{8} )}^{2} \text{/} 2}{4} ) .$$

When using N tones at a BW of 4000 Hz, where each tone is at 8 Hz, we have 512 tones. Assuming taking into account Parseval Theorem with an assumption of 2 sigma, we have now an amplitude per each tome which is equal to:

$$3 A \sqrt{N} = \sqrt{8} ⇒ A = \frac{\sqrt{8}}{3 \sqrt{N}} = 30 mv or$$

$$\text{,} {P}_{A} = \frac{{( \frac{\sqrt{8}}{3 \sqrt{N}} )}^{2} / 2}{4} = \frac{1}{9 N} = \frac{1}{9 • 512}$$

and the attenuation per each tone is

$$10 {log}_{10} [ \frac{( \frac{1}{9 • 512} )}{1} ] = - 36.6 db$$

This means that from 90 db SPL (we assume attenuation at 14000 Hz-20000 Hz of 5 dB) we would have 53.3 dBSPL. For a microphone tested at 93 dBSPL with 70 dB SNR, we can go down to 23 dB SPL for an SNR of 0 db, and for an SNR of 7 dB we can go down to 30 dB. This indicates 23 dB attenuation to the 53.3 dB SPL. The 23 db attenuation compared to 1 meter is 15 meters, which is the required distance for our acoustic transceiver.

Assuming that we use the acoustic channel BW of 14000 Hz-20000 Hz split to 10 channels each having a BW of 512 Hz, and each tone with 4 Hz. This means that we have 128 tones or attenuation per tone is:

$$10 {log}_{10} [ \frac{( \frac{1}{128} )}{1} ] = - 21 db ( Where we allow clipping in our system ) .$$

Also we can take into account the 5 dB attenuation of the non ideal flat speakers, and then we have about 21 dB savings. This means that we can use a speaker with a smaller size and a smaller power consumption. 21 db in power is about 100 times smaller, so we can replace a speaker of 10 mm×10 mm, with a speaker having a size of 1 mm×1 mm. So having 4 mm×3 mm speaker, would be good enough for our purpose. However, it is understood that for this kind of speakers, we need a total power of 1 watt/100=10 mwatts. The efficiency of a 95 dB SPL with a 1 watt at 1 m is about 2%, and for 90 dB SPL.

Microphone operation: Operating as a microphone, the switches of FIG. 3A, need to be in the down position.

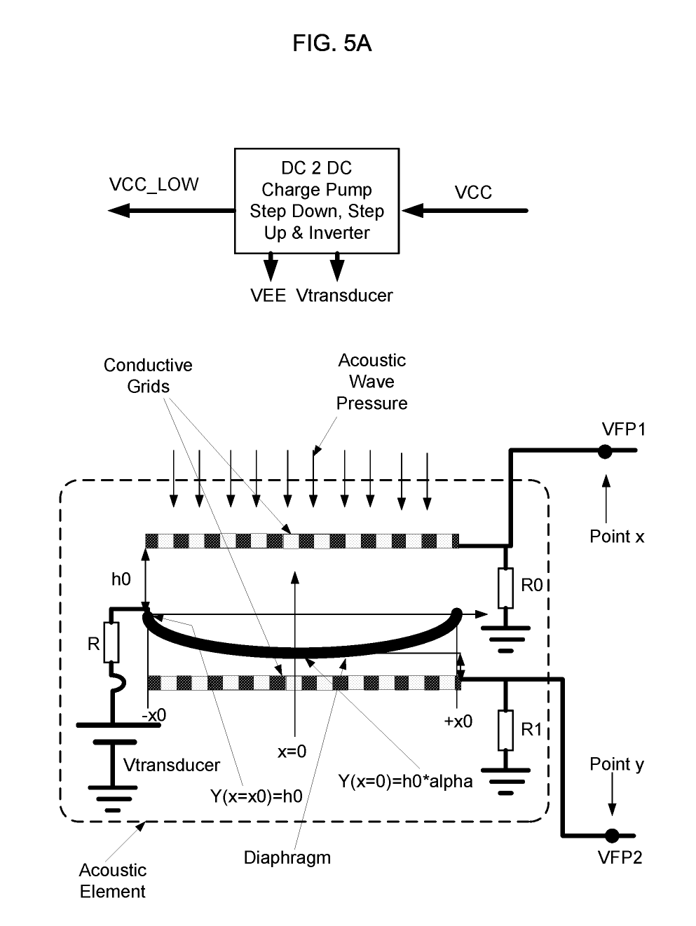

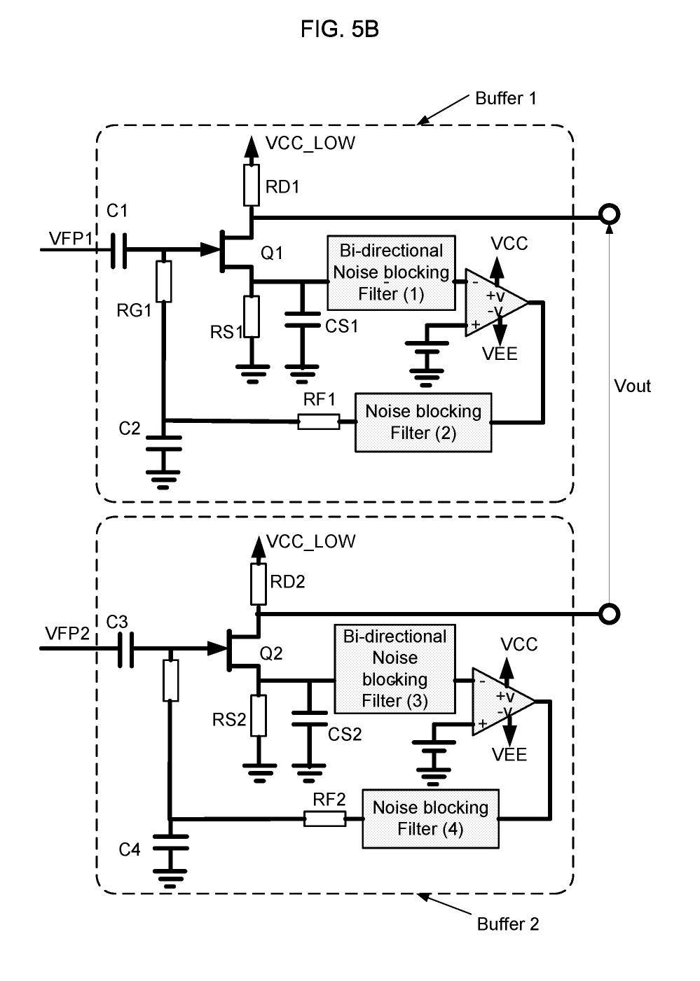

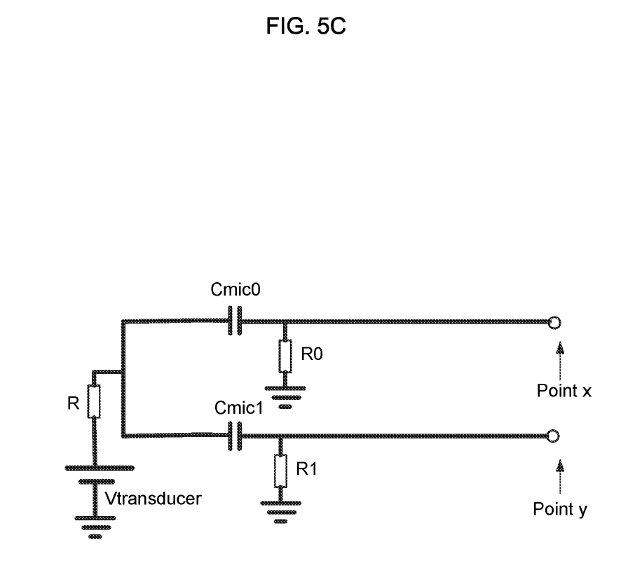

FIG. 5A is a simplified illustrations of the acoustic transducer as a microphone, according to one exemplary embodiment.

FIG. 5C is a simplified illustration of an acoustic element circuit model, according to one exemplary embodiment.

FIG. 5A and FIG. 5B taken together describe the acoustic transducer as a microphone. This is when the switches of FIG. 3 are on the down position, while connecting R0 to the upper rigid conductive grid, and R1 to the lower rigid conductive grid, according to one exemplary embodiment. This is also shown on FIG. 5A on the acoustic element block.

FIG. 5C describes the circuit model for the acoustic element of FIG. 5A, according to one exemplary embodiment.

Basically, the diaphragm with the upper grid creates a capacitor Cmic0, and the diaphragm with the lower conductive grid creates a capacitor Cmic1.

When there is no acoustic wave pressure, Cmic0 and Cmic1 both are equal and are given by:

$$Cmic 0 = Cmic 1 = \frac{{Aɛ}_{0}}{{h}_{0}} \qquad Eq . 1$$

And as the capacitor at first are charged through R and R0 for Cmic0, R and R1 for Cmic1, then both Cmic1 and Cmic0 may have Vtransducer. Q is the charge which is given by:

$$Q = {V}_{transducre} \frac{{Aɛ}_{0}}{{h}_{0}} . \qquad Eq . 2$$

Typically, when an acoustic pressure wave encounters/propagate through the upper rigid conductive grid, the diaphragm will bend as shown by FIG. 5A. This may cause the capacitor Cmic0 to decrease and the capacitor Cmic1 to increase. One capacitor may have a constant charge Q with a capacitance change that may give

$$Q = ( {V}_{transducre} + Δ V ) ( C + Δ C ) ⇒ Δ V = - {V}_{transducre} \frac{Δ C}{C} \qquad Eq . 3$$

As Cmic0 increases ΔCmic0>0 and Cmic1 decreases ΔCmic1<0, and as the output voltage is the difference between buffer 1 and buffer 2, then it may give us the maximum voltage generation on the output. For a small change in height, we can deduce that

$$\frac{{Aɛ}_{0}}{{h}_{0} ( 1 + δ )} \approx \frac{{Aɛ}_{0}}{{h}_{0}} ( 1 - δ )$$

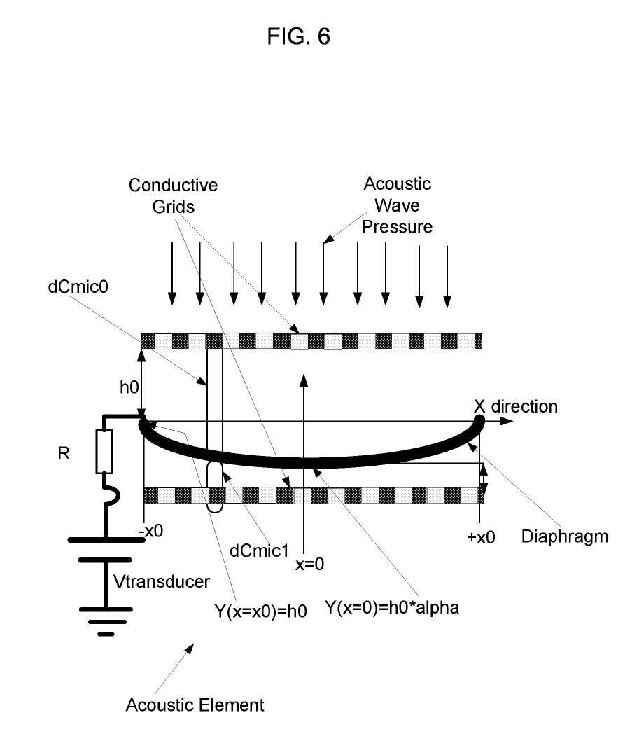

Therefore, if we consider the acoustic elements Cmic0 and Cmic1 as parallel connection of capacitors over the x direction as described by FIG. 6, then the small difference in Cmic0 can be marked as dCmic0 and the small difference in Cmic1 can be marked as dCmic1.

FIG. 6 is a simplified illustration of Cmic0 and Cmic1 as integral over X direction, according to one exemplary embodiment.

The function height for Cmico and for Cmic1 are approximated by a parabola function, and is given based on FIG. 6 by:

$$\begin{matrix}{h}_{cmic 1} ( x ) = ( α ) {h}_{0} + \frac{( 1 - α )}{{x}_{0}^{2}} {h}_{0} {x}^{2} & Eq . 4 \\ {h}_{cmic 0} ( x ) = ( 2 - α ) {h}_{0} - \frac{( 1 - α )}{{x}_{0}^{2}} {h}_{0} {x}^{2} & Eq . 5\end{matrix}$$

Then for small bending, alpha is very close to 1. It is then clear that the h0 height at x=0 will be increased by

$$2 x \frac{( 1 - α )}{{x}_{0}^{2}} {h}_{0} ,$$

and the other height will be decreased by

$$2 x \frac{( 1 - α )}{{x}_{0}^{2}} {h}_{0} .$$

Assuming that the height variations are small, then the equation

$$\frac{{Aɛ}_{0}}{{h}_{0} ( 1 + δ )} \approx \frac{{Aɛ}_{0}}{{h}_{0}} ( 1 - δ )$$

means that by performing the difference on the result from Cmic0 to Cmic1, we will double the output voltage.

Buffer operation: In order not to load the acoustic element capacitors Cmic0 and Cmic1 of FIG. 5A, a special ultra-low power buffer which is having a low input capacitance, have been designed.

Looking on buffer 1 of FIG. 5A, the buffer may include a JFET active element which is connected via a coupling capacitor C1 to point x, as seen in FIG. 5A. Point x is the signal collection for Cmic0 and as seen in FIG. 5B, the JFET is working on the saturation region, and with a low voltage supply. The JFET that is being used in this design, is an extremely wide JFET with a lowest Length. This insures a low Cgs and a high Idss. Although the fact that in FIG. 5A the buffer is described by a JFET, it is possible to construct the buffer using also a MOSFET.

Eq. 6 and Eq. 7 describe the current Id in relation to Vgs. In the saturation mode, we get amplification for both MOSFET and JFET:

$$\begin{matrix}{I}_{D} = \frac{{WC}_{ox} μ}{L} {( {V}_{GS} - {V}_{T} )}^{2} = \frac{{WC}_{ox} μ}{{LV}_{T}^{2}} {( 1 - \frac{{V}_{GS}}{{V}_{T}} )}^{2} = {{I}_{DSS} ( 1 - \frac{{V}_{GS}}{{V}_{T}} )}^{2} ⇒ {g}_{m} = - \frac{2}{{V}_{T}} \sqrt{{I}_{D} {I}_{DSS}} & Eq . 6 \\ {I}_{D} = {{I}_{DSS} ( 1 - \frac{{V}_{GS}}{{V}_{P}} )}^{2} ⇒ {g}_{m} = - \frac{2}{{V}_{P}} \sqrt{{I}_{D} {I}_{DSS}} & Eq . 7\end{matrix}$$

And the Id noise is given by:

$${i}_{D , noise , MOSFET}^{2} = 4 KT ( \frac{2}{3} ) {g}_{m} Δ f = 4 KT ( \frac{2}{3} ) \frac{2}{{V}_{T}} \sqrt{{I}_{D} {I}_{DSS}} \\ {i}_{D , noise , JFET}^{2} = 4 KT ( \frac{2}{3} ) {g}_{m} Δ f = 4 KT ( \frac{2}{3} ) \frac{2}{{V}_{P}} \sqrt{{I}_{D} {I}_{DSS}} \qquad Eq . 8$$

where K is the Boltzmann constant and T is the temperature in Kelvin degrees.

Also,

Vₒᵤₜ=−gₘR_{D}V_{IN}⇒ [symbol] Vₒᵤₜ² [symbol] =σ_{Vout}²=gₘ²R_{D}² [symbol] V_{IN}² [symbol] . Eq. 9

This is true because of CS1 & CS2 of FIG. 5A, where [symbol] V_{IN}² [symbol] and [symbol] Vₒᵤₜ² [symbol] are time averages.

$$〈 {V}_{noise , out}^{2} 〉 = {σ}_{Vnoise}^{2} = {i}_{D , noise , JFET}^{2} {R}_{D}^{2} = 4 KT ( \frac{2}{3} ) {g}_{m} Δ {fR}_{D}^{2} \qquad Eq . 8$$

Therefore the SNR of buffer 1 or buffer 2 is given by:

$$SNR = \frac{{g}_{m}^{2} {R}_{D}^{2} 〈 {V}_{IN}^{2} 〉}{4 KT ( \frac{2}{3} ) {g}_{m} Δ {fR}_{D}^{2}} = {g}_{m} \frac{〈 {V}_{IN}^{2} 〉}{4 KT ( \frac{2}{3} ) Δ f} = {g}_{m} = - \frac{2}{{V}_{X}} \sqrt{{I}_{D} {I}_{DSS}} \frac{〈 {V}_{IN}^{2} 〉}{4 KT ( \frac{2}{3} ) Δ f} \qquad Eq . 9$$

Where V_{X} is either V_{T} or V_{P} for a MOSFET or for a JFET respectively.

In order to work in the saturation region, the transistor would have to have:

V_{DS}≥V_{GS}−V_{P},for JFET

V_{DS}≥V_{GS}−V_{T},for MOSFETE 10

Microphones may use a TF202 JFET. The TF202 has an Idss=˜200 μA. This means that if we take a JFET with IDSS=100 mA, we can work with Id=200 μA/500=0.4 μA. With Vp=−1V, we have gm=0.4 m(1/ohm). In order to get a gain of 1, we need Rd=2.5K, and if we assume that Vref=5 mV, as seen in FIG. 5A, then we have RS1=RS2=7.5K.

As with equation 10, and considering equation 7, we can deduce that:

$$\begin{matrix}\vert {V}_{GS} - {V}_{P} \vert = \vert {V}_{P} \vert \sqrt{\frac{{I}_{D}}{{I}_{DSS}}} or we can deduce approximately that & Eq . 11 \\ {VCC}_{—} LOW \approx 1.1 ( {I}_{D} [ {R}_{S} + {R}_{D} ] + \vert {V}_{GS} - {V}_{P} \vert ) = 1.1 ( {I}_{D} [ {R}_{S} + {R}_{D} ] + \vert {V}_{P} \vert \sqrt{\frac{{I}_{D}}{{I}_{DSS}}} ) & Eq . 12\end{matrix}$$

For the above case, we get

$${VCC}_{—} LOW = 1.1 ( 10 K \cdot 0.4 ua + 1 v \frac{1}{500} ) = 6.6 mv .$$

With 0.4 μA we get a power consumption of 2.64 nWatts. To design a DC-to-DC step down charge pump with small capacitors some sacrifices are made. We may assume 100 kHz with transistor size of Weff=0.2 u, Leff=0.2 u with Cox=10 ff, it means that Cgs=0.2*0.2*10/3=0.13 ff, with 4 transistors for an oscillator and 4 more transistors per each stage, we get a total of 20 transistors→Ctotal=2.6 ff.

2.6 ff total capacitance for the oscillator and switches would mean that the direct consumption of the square wave oscillator and the switches is:

P=CₜₒₜₐₗV²f=2.6•10⁻¹⁵(3.2)²100,000=26 nwatts Eq. 13

The above assumes extremely low leakage process.

As the power consumption of both buffers do not exceed 5 nwatts, then we can have a simple design, which is using a 30 pF as the switching capacitor charge pump capacitors. In total, we have 8 capacitors. For 30 pF we will need 30 pF/10 ff=3000 μm² of silicon area and for 8 capacitors we will need 24000 μm². This is 154 μm×154 μm or about 0.2 mm×0.2 mm which is pretty small.

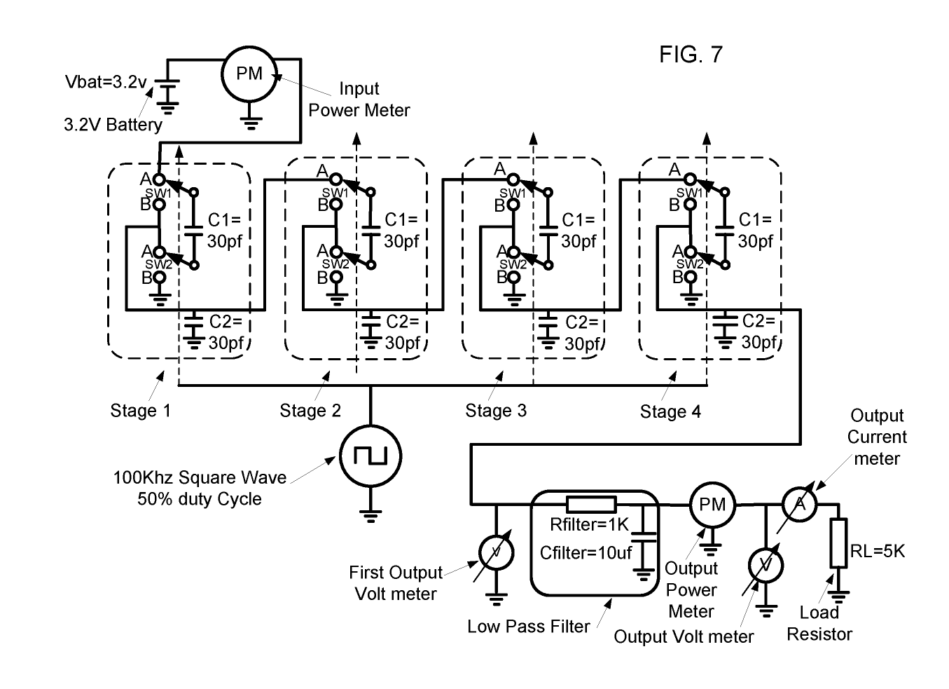

FIG. 7 is a simplified illustration of a DC-to-DC step down supply voltage, according to one exemplary embodiment.

The DC-to-DC step down supply voltage, as shown and described with reference to FIG. 7, typically generates VCC_LOW supply voltage of 6-7 mV. The circuit of FIG. 7, may include 4 stages of a divide-by-2 switch capacitors circuit. The capacitors which are used are of 30 pF. Typically, the output voltage from this circuit should be 3.2/16=200 mV. However, with a load of 5K Ohm, which indicates a current of 40 μA with 100 kHz, it suggest a ripple of 40 μA/30 pF*5 μsec=7V. This is the reason that the voltage will go down on the first and second outputs. It goes down basically to 7 mv which indicates a ripple of a few my for the first output, and this ripple is then filtered by the RC low-pass-filter of FIG. 7.

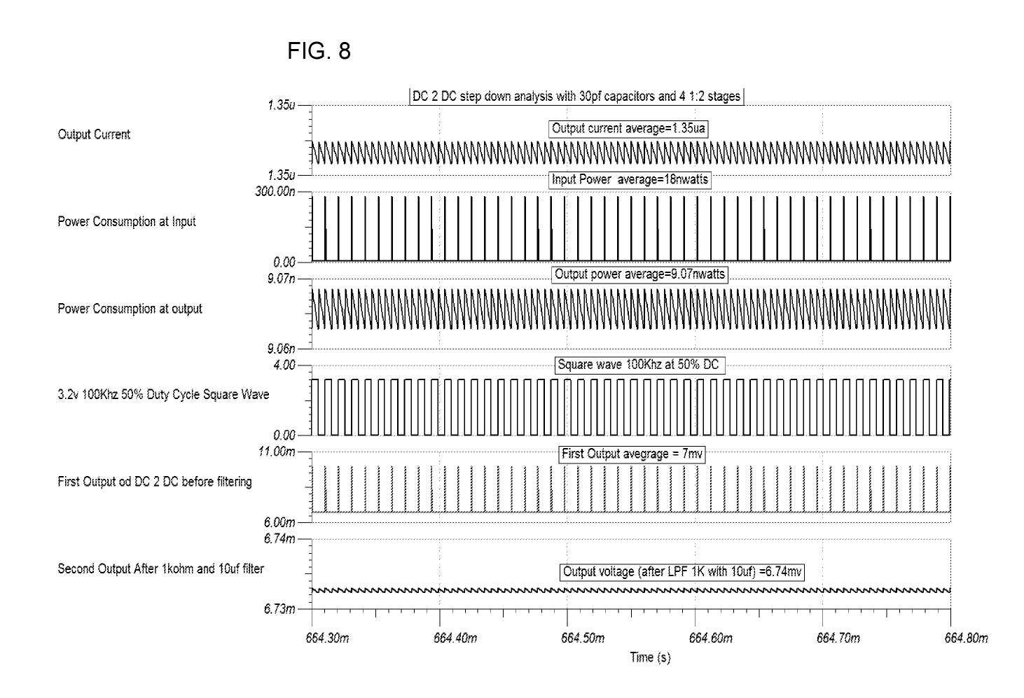

FIG. 8 is a simplified illustration of simulation results for the circuit of FIG. 7, according to one exemplary embodiment.

We assume that the 10 uf capacitor of the LPF of FIG. 7, is an external capacitor in an implementation of the acoustic transducer of FIG. 5 designed as an integrated circuit.

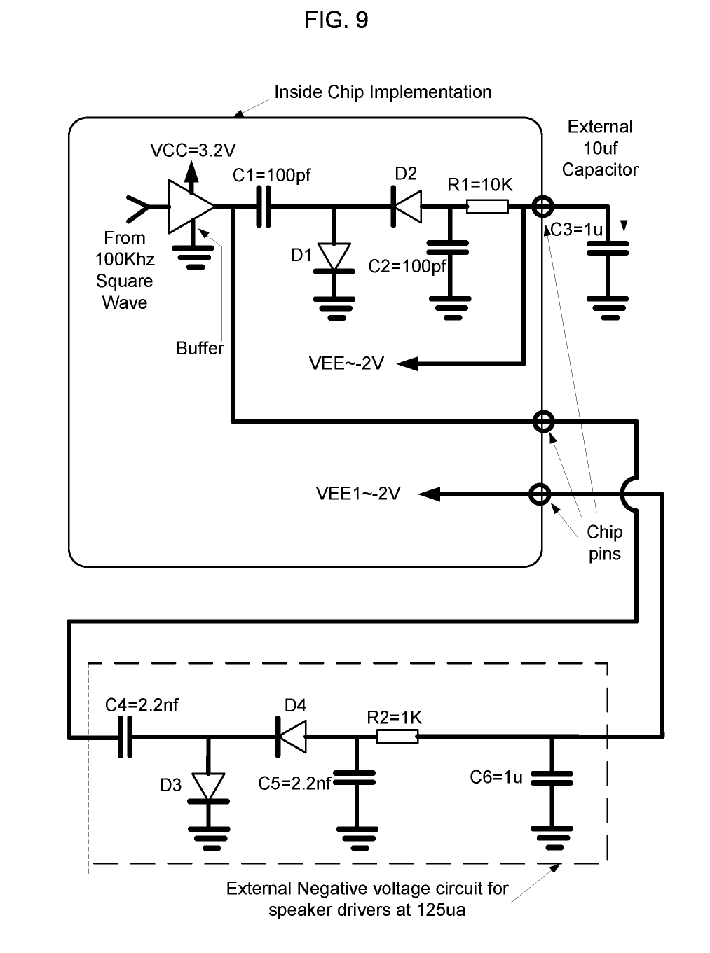

FIG. 9 is a simplified electric schematic of the negative voltage generation using a simple charge pump circuit, according to one exemplary embodiment.

FIG. 9 describes an exemplary negative voltage generation which is used for the OP amplifier of the microphone buffer, and also as a power supply for the driving amplifiers of the electrostatic speaker, according to one exemplary embodiment.

The current consumption of VEE1 of FIG. 3 is deduced from the following: As discussed above from a speaker with an efficiency of about 2%, we need 10 mwatts. From a speaker with an efficiency of 80% (expected electrostatic speaker) we have a factor of 40 reduction. This may mean that we need 10 mwatts/40=10000 uwatt/40=250 uwatts. Using a −2V supply, would mean 125 u. Therefore, the VEE and VEE1 for the microphone buffers and for the electrostatic speaker are separated.

Such acoustic transducer may keep the microphone working continuously for listening, while operating the speaker on demand when there is a need to transmit information.

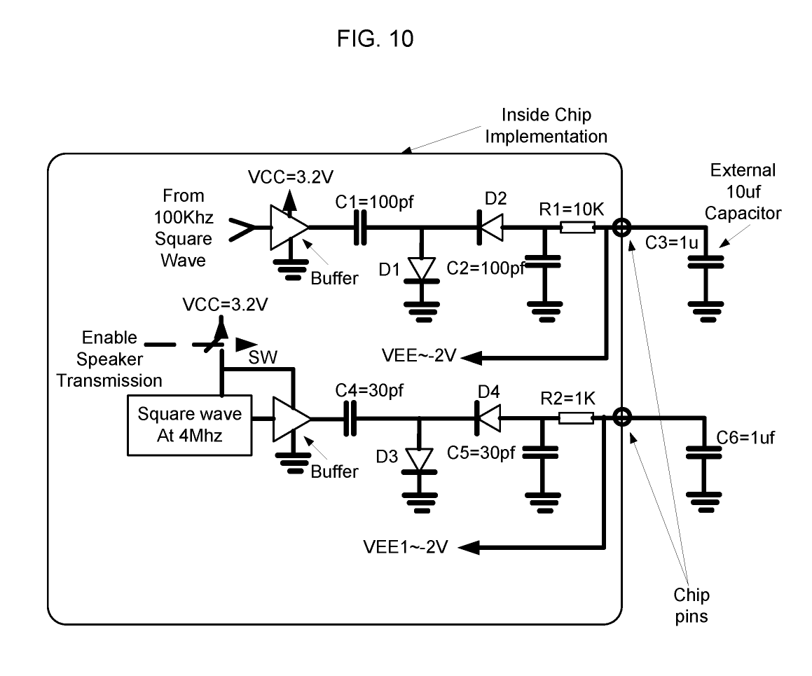

Operating this way can enable us to show an exemplary second negative supply voltage circuit, as in following FIG. 10.

FIG. 10 is a simplified electric schematic of a negative voltage supply VEE and VEE1, according to one exemplary embodiment.

As described by FIG. 10, the VEE1 negative supply voltage of the electrostatic speaker is still implemented with small capacitors of 30 pf. So it is still possible to implement this design on a chip, and still be able to supply the required current to drive the speaker at 250 watts. This is due to the fact that we use a second square wave generator, which is working 40 times faster, and hence enable to use small capacitors. R2 and C6 are used as before as an external LPF, which is designed for smoothing the ripple.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

1. An acoustic transducer comprising:
a transducer comprising:
a first rigid conductive grid;
a second rigid conductive grid; and
an elastic conductive diaphragm located between the first rigid conductive grid and the second rigid conductive grid;
a power supply having an input voltage VCC and providing a first LOW VCC supply voltage, and a second inverted voltage;
a driving circuit operating the transducer as an electrostatic speaker;
a buffer circuit operating the transducer as an electrostatic microphone;
a switch selecting between electrostatic speaker and a microphone;
a main supply input;
a signal input; and
an output.

2. The acoustic transducer according to claim 1, wherein the microphone is a Micro Electro-Mechanical System (MEMS) microphone.

3. The acoustic transducer according to claim 1, wherein at least one of the transducer, the driving circuit, and the buffer circuit, operates from 14000 Hz and above.

4. The acoustic transducer according to claim 1, wherein the power supply is a switching power supply.

5. The acoustic transducer according to claim 1, wherein the power supply is connected at its input to the main supply input, and has a first low supply voltage output, a second high supply voltage for the conductive diaphragm, and third, at least one inverted supply voltage.

6. The acoustic transducer according to claim 1, wherein the power supply low voltage is implemented using a switching capacitor step down and each inverted output is implemented using a diode clamp switch capacitor circuit, and the second high voltage is implemented using a switch capacitor voltage multiplier circuit.

7. The acoustic transducer according to claim 3, wherein the power supply low voltage has a low pass filter at the output.

8. The acoustic transducer according to claim 3, wherein each of the inverted outputs and the high voltage has a low pass filter.

9. The acoustic transducer according to claim 1, wherein the switch is a dual pole double through switch, with a first and a second normally-closed pins, and a third and a fourth normally-open pins.

10. The acoustic transducer according to claim 9, wherein the third and fourth normal open pins of the switch are connected to a first node of a first resistor and a first node of a second resistor, having their second pins attached to ground.

11. The acoustic transducer according to claim 9, wherein the electrostatic drive circuit comprises a dual buffer, wherein the first buffer is connected to the switch first normally-closed pin, and the second buffer output is connected to the switch second normally-closed pin.

12. The acoustic transducer according to claim 1, wherein the buffer circuit is comprises a single buffer connected with its input to the signal input.

13. The acoustic transducer according to claim 1, wherein the buffer comprises:
a transistor comprising a MOSFET transistor or a JFET transistor;
a bias resistor with its first node connected to the gate of the transistor;
a source terminal of the transistor connected to a first pin of a source resistor, having the second pin of the source resistor connected to ground;
a drain terminal of the transistor connected to a first pin of a drain resistor, and a second pin of the drain resistor connected to the switching a power supply low voltage;
a coupling capacitor with its first pin connected to the first or second rigid conductive grids, and its second pin connected to a gate pin the transistor;
a source capacitance connected in parallel to the source resistor;
a comparator or an OP amplifier comprising:
a first pin “+:” pin connected to a reference voltage first node, wherein the second node of the reference voltage is connected to the ground;
a second pin “−” connected to the source pin through a bi-directional noise blocking filter;
a third pin, connected to the main supply;
a fourth pin connected to an inverted supply; and
a fifth pin, which is the output, connected to an input of a noise blocking filter, having its output connected to a first pin of a feed resistor connected with its second pin to the second pin of the bias resistor, and a first pin of a capacitor having its second pin connected to the ground; and
an output node connected to the drain of the transistor.

14. The acoustic transducer according to claim 1, wherein the buffer comprises:
a first buffer with positive gain +A; and
a second buffer with a negative gain −A;
wherein the inputs of the first and second buffers are connected to the input signal.

15. The acoustic transducer according to claim 1, comprising a first buffer and a second buffer, wherein each buffer comprises a MOSFET or a JFET transistor,
wherein the first buffer comprises:
a bias resistor connected with its first node to the gate of the first buffer transistor;
the first buffer transistor source, connected to a first pin of a source resistor, having the second pin of the source resistor connected to ground;
the first buffer drain pin connected to the first pin of a first drain resistor, and the second pin of the first drain resistor connected to the switching power supply low voltage;
a coupling capacitor connected with its first pin to the first conductive grid and its second pin connected to the first buffer transistor gate pin;
a source capacitance connected in parallel to the source resistor;
a first comparator or OP amplifier, comprising 5 pins, wherein:
a first pin “+:” pin connected to a reference voltage first node, where the second node of the reference voltage is connected to the ground;
a second pin “−” connected to the first buffer transistor source pin through a first bi-directional noise blocking filter;
a third pin, connected to the main supply;
a fourth pin connected to the inverted supply; and
a fifth (output) pin connected to an input of a first noise blocking filter, having its output connected to a first pin of a first feedback resistor connected with its second pin to a second pin of a bias resistor and a first pin of a capacitor having it second pin connected to the ground; and
a first output node connected to the drain of the first buffer transistor; and
wherein the second buffer comprises:
a bias resistor connected with its first node to the gate of the second buffer transistor;
a second buffer transistor source connected to a first pin of a source resistor, having the second pin of the source resistor connected to ground;
a second buffer drain pin connected to the first pin of a second drain resistor and the second pin of the second drain resistor connected to the switching power supply low voltage;
a coupling capacitor connected with its first pin to the second conductive grid and it second pin connected to the second buffer transistor gate pin;
a source capacitance connected in parallel to the source resistor;
a second comparator or OP amplifier, having 5 pins:
a first pin “+:” pin connected to a reference voltage first node, wherein the second node of the reference voltage is connected to the ground;
a second pin “−” connected to the second buffer transistor source pin through a second bi-directional noise blocking filter;
a third pin, connected to the main supply;
a fourth pin connected to the inverted supply; and
a fifth pin, which is the output, is connected to an input of a second noise blocking filter, having its output connected to a first pin of a second feedback resistor, which is connected with its second pin to the second pin of the bias resistor, and a first pin of a capacitor having its second pin connected to the ground; and
a second output node connected to the transistor drain of the second buffer transistor.

16. The acoustic transducer according to claim 12, wherein the output is taken as a differential output between the first output and the second output.

17. The acoustic transducer according to claim 6, wherein the low voltage switching capacitor circuit works with low frequency and the inverted voltage supply is working with high frequency.

18. The acoustic transducer according to claim 14, wherein the inverted voltage supply oscillator has two states, the first is enable wherein the oscillator works, the second is disable wherein the high frequency oscillator is disabled.

19. The acoustic transducer according to claim 15, wherein the acoustic transducer comprises a control pin comprising:
a first state connecting the first and second rigid conductive grids to the first and second buffers output pins; and
a second state connecting a first pin of a first resistor to the first rigid conductive grid, and the first pin of a second resistor to the second rigid conductive grid.

20. A method for operating an acoustic transducer comprising:
providing a transducer comprising:
a first rigid conductive grid;
a second rigid conductive grid; and
an elastic conductive diaphragm located between the first rigid conductive grid and the second rigid conductive grid;
providing electric circuitry comprising:
a power supply having an input voltage VCC and providing a first LOW VCC supply voltage, and a second inverted voltage;
a driving circuit operating the transducer as an electrostatic speaker;
a buffer circuit operating the transducer as an electrostatic microphone;
a switch selecting between electrostatic speaker and a microphone;
a main supply input;
a signal input; and
an output; and
operating the switch to alternate the transducer between electrostatic speaker mode and electrostatic microphone mode.
